(19) United States
(12) Patent Application Publication
(10) Pub. No.: US 2014/0033118 A1
(43) Pub. Date: Jan. 30, 2014

(54) Space management in windowed environments

(71) Applicant: Peter J. Baird, Arlington, MA (US)

(72) Inventor: Peter J. Baird, Arlington, MA (US)

(73) Assignee: Adobe Systems Incorporated, San Jose, CA (US)

(21) Appl. No.: 11/471,885

(22) Filed: Jun. 21, 2006

(51) Int. Cl. G06F 3/0481

(52) U.S. Cl. CPC G06F 3/0481
USPC 715/800

(57) ABSTRACT

Space management in windowed environments is described, including drawing a window including a first pane and a second pane adjacent to the first pane, receiving an input to activate the first pane, and expanding the first pane and contracting the second pane in response to the receiving the input.

### FIELD OF THE INVENTION

The present invention relates generally to software. More specifically, space management in windowed environments is described.

### BACKGROUND OF THE INVENTION

Windowed environments, such as graphical user interfaces (GUIs), facilitate the display of software applications on personal computers. For example, an e-mail client, a web browser, or a word processor may be displayed in a window. A windowed environment may include multiple windows running multiple applications simultaneously displayed in a GUI, allowing for multitasking.

A window may include one or more panes, which are subdivisions of windows that may act independently or in concert. Panes may help organize the display of a windowed application. For example, an email client may include several panes: one displaying a list of messages, one displaying a list of email boxes, and one displaying the detailed text of a selected message.

Panes may further be related to one another. For example, two panes may have a master/detail relationship. One pane may display a list of items available for viewing. A user may select one of the items from the list, and detail related to that item is displayed in the other pane. For example, an e-mail client may include a list of messages in an inbox in one pane, and the text of a message selected from the list in another pane. However, it may be difficult to legibly and adequately display the list and the detail simultaneously on a user's screen.

Thus, what is needed is a solution for space management for windowed environments without the limitations of conventional techniques.

### BRIEF DESCRIPTION OF THE DRAWINGS

Various embodiments of the invention are disclosed in the following detailed description and the accompanying drawings:

FIGS. 1A-1F illustrate space management in windowed environments according to various embodiments;

FIG. 2 illustrates manually adjusting a divider and restoring space management after the adjusting according to an embodiment

FIG. 3 is a flowchart describing a process for performing space management in windowed environments according to various embodiments; and

FIG. 4 is a block diagram illustrating an exemplary computer system suitable for space management in windowed environments, in accordance with various embodiments.

### DETAILED DESCRIPTION

Various embodiments may be implemented in numerous ways, including as a system, a process, an apparatus, or a series of program instructions on a computer readable medium such as a computer readable storage medium or a computer network where the program instructions are sent over optical or electronic communication links. In general, operations of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

According to various embodiments, space management in windowed environments is described. A window may include a first pane and second pane adjacent to the first pane. The window may further include a divider between the first pane and the second pane. When a user activates the first pane, for example, by moving a cursor into the first pane, the first pane expands and the second pane contracts to aid in viewing the contents of the first pane. Likewise, if the user activates the second pane (e.g., by moving the cursor into the second pane), the first pane contracts and the second pane expands.

### Expansion and Contraction of Panes in Response to a User Input

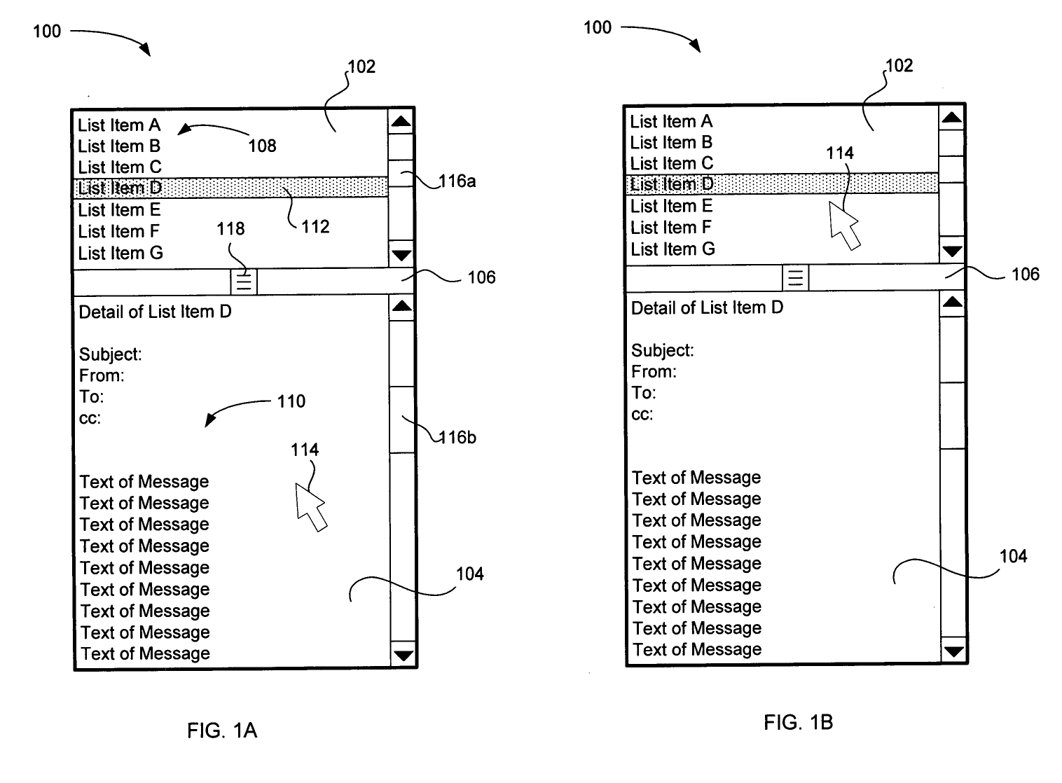

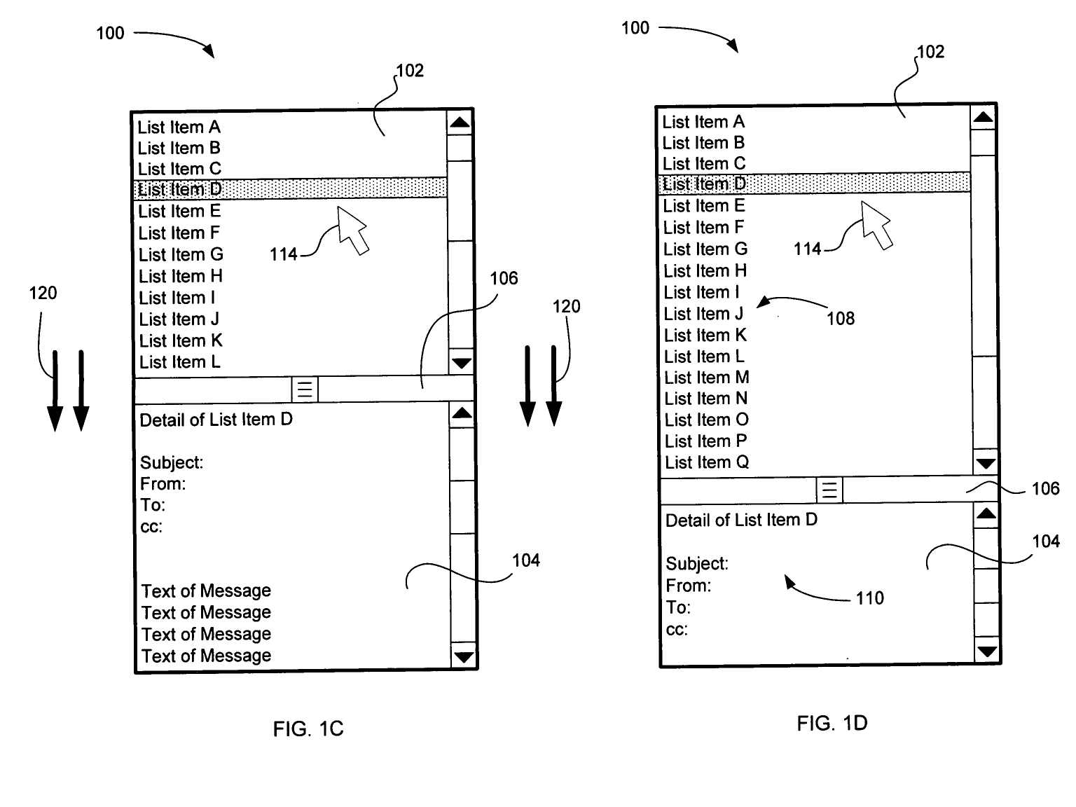

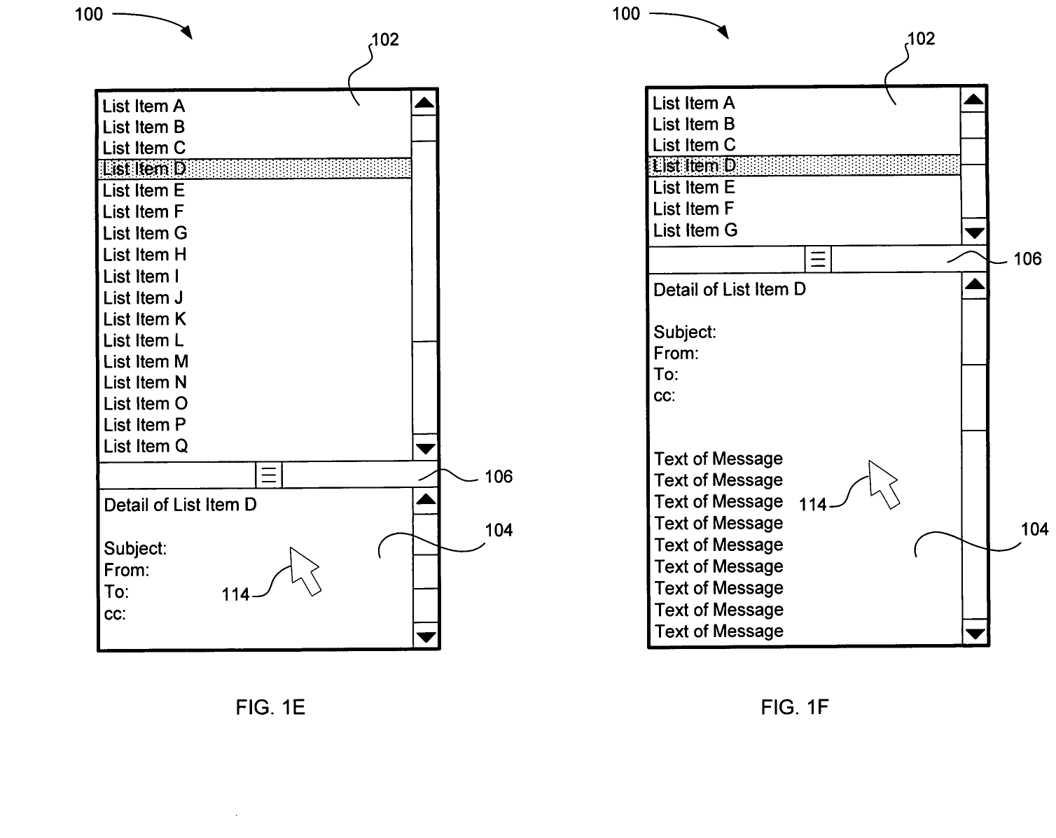

FIGS. 1A-1F illustrate space management in windowed environments according to various embodiments. According to these embodiments, a window including multiple panes may be managed by resizing (i.e., expanding or contracting) panes within the window when an event activating the pane occurs. The event may be, for example, a mouse-over of the pane.

FIG. 1A illustrates a window 100 including two adjacent panes 102 and 104. In this context, a window may display all or a portion of a windowed environment, such as those used with graphical user interfaces (GUIs). The window 100 may include multiple panes in which information, such as text, graphics, or video, may be displayed. For example, the window 100 may display the output of a program such as an e-mail client or a word processor. A divider 106 visually designates a boundary between the first pane 102 and the second pane 104. As is explained below, the divider 106 may move with the panes 102 and 104 when the panes 102 and 104 are resized.

According to an embodiment, the panes 102 and 104 may have a master/detail relationship. For example, if the window 100 displays an e-mail client, the first pane 102 may include a list 108 showing received e-mail messages, and the second pane 104 may include a detail 110 of a selected message. A highlight bar 112 highlights the e-mail message in the list 108 that corresponds to the detail 110. A user may control a cursor 114 (using, for example, a mouse or other pointing device) to select another item of the list 108. The detail 110 shown in the second pane 104 would then change to reflect the new selection.

The list 108 and the detail 110 may have too much information to display legibly in the panes 102 and 104, respectively. A portion of the list 108 and/or detail 110 may be displayed and the remainder can be brought into view using the scroll bars 116a and 116b. Alternatively, using various embodiments of space management as described herein, a user may activate one of the first pane 102 and the second pane 104 to expand the activated pane and expose more of its content.

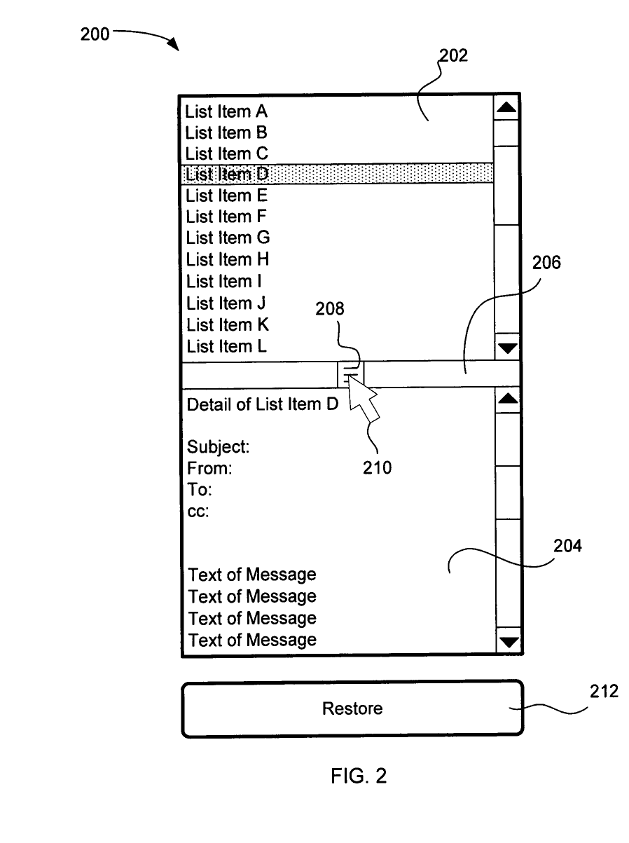

According to an embodiment, when a user makes an input to activate either the first pane 102 or the second pane 104, the pane that is activated expands to reveal more information, while the other, deactivated pane contracts. The divider 106 between the panes 102 and 104 also moves while a pane is expanding or contracting. According to an embodiment, the total area of the panes 102 and 104 remains approximately constant during the expansion and contraction so that the expanding and the contracting maintain a constant, original size (i.e., the size prior to activation of a pane) of the window 100. The expansion and contraction of planes may also be animated. The divider 106 further includes a grab handle 118, which a user may use to manually position the divider 106, thereby manually resizing the panes 102 and 104. The function of the grab handle with relation to the window management described herein is further discussed regarding FIG. 2.

According to an embodiment, a pane is activated when a user has taken some action regarding the pane. For example, a user may “mouse-over” the pane. A mouse-over may involve moving a cursor controlled by a pointing device (such as a mouse) into an area occupied by the pane. Alternatively, a pane may be activated using a keyboard, for example, by issuing a keystroke that selects the pane. Different techniques for activating a pane may be used as desired.

As shown in FIG. 1A, the cursor 114 is currently in the second pane 104. According to an embodiment, when window management is operating and the cursor 114 is in a pane (e.g., the cursor 110 is moused-over the second pane 104), that pane is expanded to increase the area visible for the user. The activated pane (e.g., the second pane 104) may have a predetermined size, for example, 70% of the height of the window 100.

If a user wants to expand the first pane 102, for example to see more of the list 108 displayed in the first window 102, the user may move the cursor 114 to the first pane 102. FIG. 1B illustrates the cursor 114 moved to the first pane 102 from the second pane 104. When an input (e.g., a user input using a mouse or other pointing device) is received to move the cursor 114 to the first pane 102, the first pane 102 expands to a predetermined or dynamically determined size.

FIGS. 1C and 1D illustrate the expansion of the first pane 102. The first pane 102 may expand to a first size, which may be, for example, a percentage of the window 100 (e.g., the first pane may expand to a first size of 70% of the height of the window 100), a fixed size (e.g., 600 pixels), or a size large enough to show the entire contents of the first pane 102. The second pane 102 contracts to a second size, which may be a percentage (e.g., 30% of the height of the window 100) or a fixed size (e.g., 200 pixels). A combination of these conditions may also be used. For example, the first pane 102 may expand to either seventy percent the size of the window 100, or to a size large enough to display the entire contents of the first pane 102, whichever is smaller. Other conditions may also be used.

FIG. 1C illustrates the first pane 102 expanding and the second pane 104 contracting according to an embodiment. The window 100 may show the expansion and contraction the panes 102 and 104, respectively, as an animated display. As the first pane 102 is expanding, gradually more and more of the content of the first pane 102 is revealed. Here, more of the list 108 can be seen. Simultaneously, the divider 106 is moving down toward the second pane 104 (as indicated by arrows 120), while the second pane 104 is contracting. The animation demonstrated in FIG. 1C may optionally be shown to illustrate that the panes 102 and 104 are expanding and contracting.

FIG. 1D illustrates the window 100 after the first pane 102 has expanded in response to the cursor 114 moving to the first pane 102 (i.e., activating the first pane 102). In some embodiments, the first pane 102 has expanded and the second pane 104 has contracted. A user may view the content of the first pane 102, and may, for example, choose another item from the list 108 displayed in the first pane 102. When the user selects another item, the detail 110 of the item is displayed in the second pane 104.

FIGS. 1E and 1F illustrate the activation and expansion of the second pane 104, according to an embodiment. If a user wishes to view the second pane 104 in more detail, the user may activate the second pane 104 by moving the cursor 114 into the second pane 104. As mentioned above, other techniques may also be used to activate panes. The movement of the cursor 114 into the second pane 104 is shown in FIG. 1E. In FIG. 1F, the second pane 104 has expanded, the first pane 102 has contracted, and the divider 106 has moved in concert with the expansion and contraction of the panes 102 and 104. The expansion and contraction of the panes may also be animated, as when the first pane 102 expanded (as shown in FIG. 1C).

Although certain techniques for space management are disclosed here, it is understood that other variations are possible. For example, any number of panes (e.g., three or more) may be included in a window and various different formulas may be used for determining a size of the panes after expansion and contraction. Additionally different configurations of the panes may also be used. For example, the panes may be arranged horizontally rather than vertically.

### Manual Adjustment of Panes and Restoration of Space Management

FIG. 2 illustrates manually adjusting a divider and restoring space management after the adjusting according to an embodiment. A window 200 includes a first pane 202 and a second pane 204 adjacent to each other. The panes 202 and 204 are separated by a divider 206. The divider 206 includes a grab handle 208, which a user may select with a cursor 210. The grab handle 208 allows a user to change the position of the divider 206, thereby manually adjusting the size of the panes 202 and 204. Although the grab handle 208 is described here, other techniques for manually adjusting the divider 206 (and therefore the panes 202 and 204) may also be used.

According to an embodiment, when a user changes the size of the panes 202 and 204 using the grab handle 208, the space management techniques illustrated in FIGS. 1A-1F are disabled. If the user moves the cursor 210 between the two panes 202 and 204, the panes 202 and 204 retain their user-designated size. If the user wishes to restore the space management, the user may select a restore button 212. Once the restore button 212 has been selected, the panes 202 and 204 may return to predetermined default sizes (e.g., the first pane 202 occupies 70% of the window 200, and the second pane 204 occupies 30%) either instantly, or once a user moves the cursor 210 back to within one of the panes 202 or 204. Once space management is restored, the window 200 acts in the manner of the window 100 as shown in FIGS. 1A-1F.

### Process for Performing Space Management

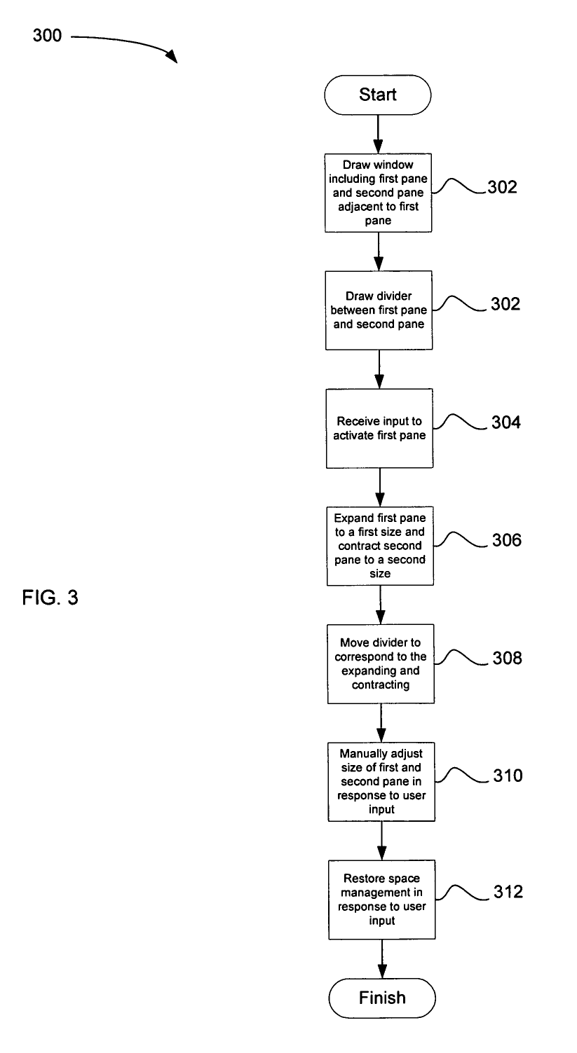

FIG. 3 is a flowchart describing a process 300 for performing space management in windowed environments, according to various embodiments. Space management, according to an embodiment, includes expanding an activated pane of a window to increase the amount of viewable content in that window. The pane may be activated using, for example, a mouse-over (e.g., moving a cursor into the pane). The window may further include adjustable panes, and space management may be restored after manual adjustment in response to a user input.

In block 302, a window, including a first pane and a second pane adjacent to the first pane, is drawn. The first pane and the second pane may be, for example, the first pane 102 and the second pane 104 as shown in FIGS. 1A-1F. The window may be a window in a windowed environment (e.g., a GUI), and may display an application or a portion of an application. For example, the window may display an e-mail client (or portion thereof) or similar application. The panes may further have a master/detail relationship; the first pane may include a list of items which can be selected, and the second pane may display detail related to the selected item.

In block 304, a divider is drawn between the first pane and the second pane. The divider (e.g., the divider 106) visually separates the first pane and the second pane, and may also include a grab handle (e.g., the grab handle 208) used to manually adjust the size of the first pane and the second pane.

In block 306, an input to activate the first pane is received. The input may be an input to move a cursor into the first pane, for example. The input may be a mouse-over including a movement using a pointing device such as a mouse or a trackball.

In block 308, the first pane is expanded to a first size and second pane is contracted to a second size. The first pane and the second pane may be simultaneously expanded and contracted, and the movements may be animated. For example, the first pane may expand from 30% of the size of the window to 40%, then 50%, then 60%, and finally 70% of the size of the window. Likewise, the second pane may contract from 70% of the size of the window, to 60%, then 50%, then 40%, and finally 30% of the size of the window.

The first size of the first pane and the second size of the second pane may be determined using various techniques. For example, the first size and the second size may be a percentage of the size of the window. Alternatively, the first size may be a size large enough to show the entire contents of the first pane. A combination of the techniques may also be used; the first pane may expand to whichever is smaller, a size large enough to show the entire contents of the first pane or 70% of the size of the window. Other techniques may also be used.

In block 310, the divider is moved to correspond to the expanding and contracting. The divider may be redrawn at various intervals to show the boundaries of the first pane and the second pane as the first pane and the second pane expand and contract, respectively.

In block 312, the divider is moved to manually adjust the size of the first pane and the second pane in response to a user input. The divider may be moved by using a grab handle (e.g., the grab handle 208). The user may click the grab handle and drag the divider to whatever position the user desires. In block 314, the user may restore the space management. The user may restore the space management by, for example, selecting a button such as the button 212. When space management is restored, the panes may remain the same, or may expand or contract to a default setting.

Various operations are described in the blocks 302-314. It is understood that certain of these operations are optional for the various embodiments described herein. For example, the operations described in blocks 310-312 may be omitted, and other operations may be added where appropriate.

### An Exemplary Computer System

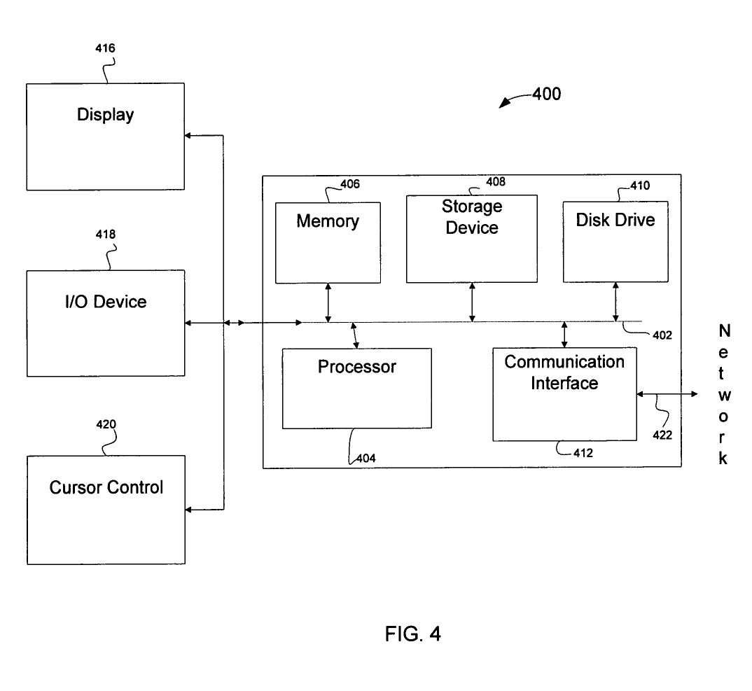

FIG. 4 is a block diagram illustrating an exemplary computer system suitable for space management in windowed environments, in accordance with various embodiments. In some embodiments, a computer system 400 may be used to implement computer programs, applications, methods, processes, or other software to perform the above-described techniques. The computer system 400 includes a bus 402 or other communication mechanism for communicating information, which interconnects subsystems and devices, such as a processor 404, a system memory 406 (e.g., RAM), a storage device 408 (e.g., ROM), a disk drive 410 (e.g., magnetic or optical), a communication interface 412 (e.g., modem or Ethernet card), a display 414 (e.g., CRT or LCD), an input device 416 (e.g., keyboard), and a cursor control 418 (e.g., mouse or trackball).

According to some embodiments, the computer system 400 performs specific operations by processor 404 executing one or more sequences of one or more instructions stored in the system memory 406. Such instructions may be read into the system memory 406 from another computer readable medium, such as the static storage device 408 or the disk drive 410. In some embodiments, hard-wired circuitry may be used in place of or in combination with software instructions to implement various embodiments.

Although the foregoing examples have been described in some detail for purposes of clarity of understanding, the invention is not limited to the details provided. There are many alternative ways of implementing the invention. The disclosed examples are illustrative and not restrictive.

1. A method comprising:
drawing a window for a particular application, wherein the window includes a first pane of the application and a second pane of the same application adjacent to the first pane, wherein the window further includes a divider between the first pane and the second pane, and wherein the first pane displays a plurality of content items;
receiving an input to activate the first pane, wherein the input activates the first pane and does not activate the second pane;
in response to said receiving the input that activates the first pane:
expanding the first pane and contracting the second pane, wherein said expanding and said contracting comprise automatically moving the divider to correspond to the expanding and the contracting, wherein the divider is automatically moved in response to the input that activates the first pane rather than in response to an input directed to the divider;
while the first pane is active, receiving another input to activate the second pane and not the first pane; and
in response to said receiving the another input:
expanding the second pane and contracting the first pane, wherein said expanding and said contracting comprise automatically moving the divider to correspond to the expanding and the contracting, wherein the divider is automatically moved in response to the another input that activates the second pane rather than in response to an input directed to the divider.

2. (canceled)

3. The method of claim 1, wherein the receiving the input comprises receiving the input to move a cursor into the first pane.

4. The method of claim 1, wherein the expanding maintains an original size of the window.

5. The method of claim 1, wherein the expanding further comprises revealing a content of the first pane.

6. The method of claim 5, wherein the revealing the content of the first pane comprises revealing a list corresponding to a detail of the second pane.

7. The method of claim 1, further comprising adjusting the divider in response to an input selecting and moving the divider.

8. The method of claim 1, wherein expanding the first pane comprises expanding the first pane to a predetermined size relative to the window.

9. (canceled)

10. A method comprising:
drawing a window for a particular application, wherein the window includes a first pane of the application and a second pane of the same application adjacent to the first pane, wherein the window further includes a divider between the first pane and the second pane;
receiving an input to mouse-over the first pane;
in response to said receiving the input to mouse-over the first pane:
expanding the first pane to a first size and contracting the second pane to a second size, wherein said expanding and said contracting comprise automatically moving the divider to correspond to the expanding and the contracting, wherein the divider is moved in response to the input to mouse-over the first pane, rather than in response to an input directed to the divider, wherein the input to mouse-over the first pane comprises moving a mouse cursor over the first pane;
while the first pane is expanded relative to the second pane, receiving another input to mouse-over the second pane; and
in response to said receiving the another input:
expanding the second pane and contracting the first pane, wherein said expanding and said contracting comprise automatically moving the divider to correspond to the expanding and the contracting, wherein the divider is moved in response to the another input to mouse-over the second pane, rather than in response to an input directed to the divider, wherein the another input to mouse-over the second pane comprises moving the mouse cursor over the second pane.

11. The method of claim 10, further comprising determining the first size based on a first predetermined percentage of the window and determining the second size based on a second predetermined percentage of the window.

12. The method of claim 11, wherein the expanding and the contracting maintain an original size of the window.

13. (canceled)

14. A system, comprising:
a memory configured to draw a window for a particular application; and
a processor configured to:
draw a first pane of the application and a second pane of the same application adjacent to the first pane and a divider between the first pane and the second pane in the window, wherein the first pane displays a plurality of content items;
receive an input to activate the first pane, wherein the input activates the first pane and does not activate the second pane;
in response to said receiving the input that activates the first pane:
expand the first pane and contract the second pane, wherein said expanding and said contracting comprise automatically moving the divider to correspond to the expanding and the contracting, wherein the divider is automatically moved in response to the input that activates the first pane rather than in response to an input directed to the divider;
while the first pane is active, receive another input to activate the second pane and not the first pane;
in response to said receiving the another input that activates the second pane:
expand the second pane and contract the first pane, wherein said expanding and said contracting comprise automatically moving the divider to correspond to the expanding and the contracting, wherein the divider is automatically moved in response to the another input that activates the second pane rather than in response to an input directed to the divider.

15. The system of claim 14, wherein the processor configured to receive an input comprises the processor configured to receive the input to move a cursor into the first pane.

16. The system of claim 14, wherein the processor configured to expand the first pane comprises the processor configured to expand the first pane to a predetermined size relative to the window.

17. (canceled)

18. A computer program product embodied in a computer readable medium and comprising computer instructions for:
drawing a window for a particular application, wherein the window includes a first pane of the application and a second pane of the same application adjacent to the first pane, wherein the window further includes a divider between the first pane and the second pane, and wherein the first pane displays a plurality of content items;
receiving an input to activate the first pane, wherein the input activates the first pane and does not activate the second pane;
in response to said receiving the input that activates the first pane:
expanding the first pane and contracting the second pane, wherein said expanding and said contracting comprise automatically moving the divider to correspond to the expanding and the contracting, wherein the divider is automatically moved in response to the input that activates the first pane rather than in response to an input directed to the divider;
while the first pane is active, receiving another input to activate the second pane and not the first pane; and
in response to said receiving the another input:
expanding the second pane and contracting the first pane, wherein said expanding and said contracting comprise automatically moving the divider to correspond to the expanding and the contracting, wherein the divider is automatically moved in response to the another input that activates the second pane rather than in response to an input directed to the divider.

19. The computer program product of claim 18, wherein the receiving the input comprises receiving the input to move a cursor into the first pane.

20. The computer program product of claim 18, wherein expanding the first pane comprises expanding the first pane to a predetermined size relative to the window.

21. (canceled)
